(19) United States
(12) Patent Application Publication
(10) Pub. No.: US 2024/0293690 A1
(43) Pub. Date: Sep. 5, 2024

(54) Fire Containment Connector

(71) Applicant: Wildfire Fight, LLC, Houston, TX (US)

(72) Inventor: Lester Ray Wisegerber, Dayton, TX (US)

(21) Appl. No.: 18/637,141

(22) Filed: Apr. 16, 2024

(51) Int. Cl. A62C 3/02; A62C 33/06

(52) U.S. Cl. CPC A62C 3/0264; A62C 33/06; A62C 99/0072

(57) ABSTRACT

Described herein is a fire containment connector. It includes a female end to connect with a male coupling on a first fire hose and a male end to connect with a female coupling on a second fire hose. The fire containment connector also includes a cylindrical base that routes water from the first fire hose to the second fire hose. A cylindrical section of a sleeve rotates about a main body of the cylindrical base until the fire containment connector is in an open position. An oblong opening in the main body allows water to exit the cylindrical base and enter a hollow protuberance of the sleeve when the oblong opening and the hollow protuberance are aligned. A curved slit in the hollow protuberance expels a fan-shaped spray of water and a wall of water is formed.

### TECHNICAL FIELD

The present disclosure relates generally to techniques for wildfire containment. More specifically, the present techniques relate to a fire containment connector that is used to form a wall of water in the path of an advancing wildfire.

### BACKGROUND ART

Various techniques are used to contain wildfires. Firefighters use single stream hoses to deliver water to the base of a wildfire. Other containment techniques utilize control lines and controlled burns. A control line is a natural or man-made boundary that firefighters use to limit the spread of a wildfire. Firefighters start controlled burns that consume wildfire-sustaining fuel such as grass, plants, bushes, dried leaves, pine needles, and timber. Controlled burns are intended to eliminate fuel before a wildfire can reach it. Burnouts and backburns are examples of controlled burns. A burnout is a small fire that removes fuel just inside a control line. A backburn is a blaze started inside a control line and downwind of a wildfire. The blaze moves toward the wildfire and burns fuel between the wildfire and the control line.

### BRIEF DESCRIPTION OF DRAWINGS

FIG. 1 is an illustration of the cylindrical base of the fire containment connector.

FIG. 2 is an illustration of the sleeve that rotates about the cylindrical base shown in FIG. 1.

FIG. 3 is an illustration of the assembled fire containment connector.

FIG. 4 is a flow-through view of the assembled fire containment connector shown in FIG. 3.

FIG. 5 is a process flow diagram of a method for containing a wildfire using the fire containment connector shown in FIGS. 3 and 4.

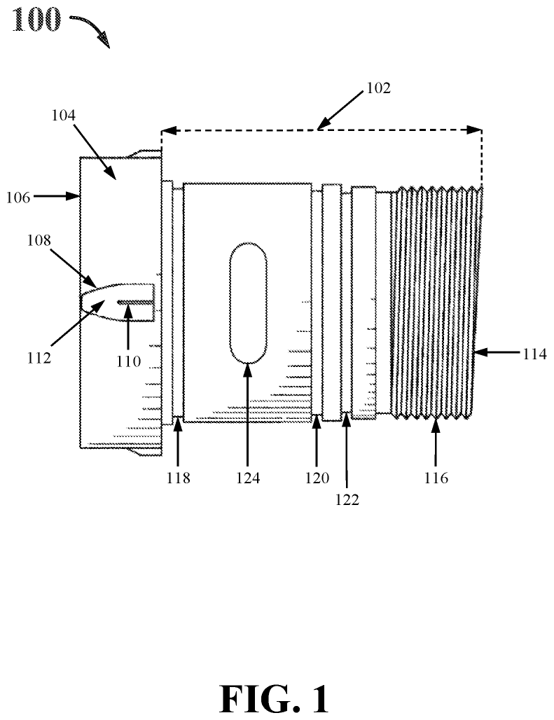

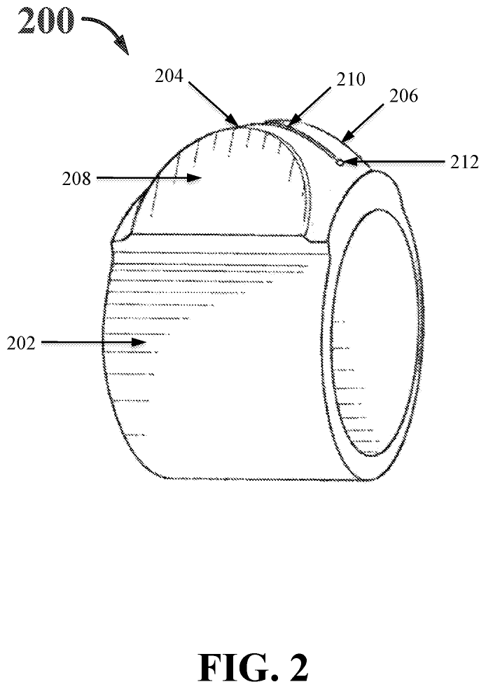

The same numbers are used in the disclosure and the figures to reference like features. Numbers in the 100s refer to features originally found in FIG. 1; numbers in the 200s refer to features originally found in FIG. 2; and so on.

### DETAILED DESCRIPTION

The National Interagency Fire Center (“NIFC”) has reported that 55,571 wildfires in the United States scorched 2,633,636 acres in 2023. In addition, these wildfires emitted approximately 5.7 billion tons of carbon dioxide (“CO₂”) into the atmosphere. This situation is especially concerning because CO₂ emitted from wildfires contributes to global warming, creating conditions that result in more wildfires and even greater CO₂ emissions. These statistics emphasize the need for wildfire containment techniques that supplement those techniques already in use.

The various containment techniques may have limited effectiveness for a number of reasons. For example, the use of single stream hoses is not a comprehensive approach to containing wildfires. Only small sections of a wildfire's periphery are contained using this technique while other sections continue to blaze. The use of single stream hoses is resource-intense. Numerous firefighters are needed to manipulate the heavy fire hoses. Furthermore, a considerable amount of equipment is required to support the firefighters' efforts. Accordingly, the use of single stream hoses may divert personnel and equipment from more critical areas of a wildfire.

Control lines are positioned where they can intercept an advancing wildfire. Their placement is determined by considering a variety of factors that affect wildfire behavior. A change in any of these factors may have an unpredictable effect on a wildfire. For example, embers may be carried aloft and ignite new fires on the other side of a control line.

Burnouts and backburns are fires intentionally started by firefighters. These fires are intended to limit the fuel available to a wildfire. However, despite precautions, there is always a risk that burnouts and backburns will escalate unexpectedly and become uncontrollable. They may cross control lines, extend the reach of a wildfire, and pose a threat to nearby communities.

There is always a risk to firefighters when they implement a wildfire confinement technique. For example, firefighters using single stream hoses may expose themselves to intense heat, smoke, and flames if they get too close to a wildfire. Firefighters are at risk during ignition and control of burnouts and backburns. The unpredictability of wildfires can add to the danger faced by firefighters when they apply any of the containment techniques. Additional wildfire containment techniques are needed to reduce the risks to firefighters and nearby populated areas.

The present disclosure describes additional techniques for containing wildfires that diminish the danger to firefighters and nearby communities. For example, a fire containment connector may have a female end to connect with a male coupling on a first fire hose. A male end may connect with a female coupling on a second fire hose. The fire containment connector may include a cylindrical base that routes water from the first fire hose to the second fire hose. A cylindrical section of a sleeve may rotate about a main body of the cylindrical base until the fire containment connector is in an open position. An oblong opening in the main body may allow water to exit the cylindrical base and enter a hollow protuberance of the sleeve when the oblong opening and the hollow protuberance are aligned. A curved slit in the hollow protuberance may expel a fan-shaped spray of water and form a wall of water. Various examples of the present techniques are described below with reference to the accompanying figures.

FIG. 1 is an illustration of the cylindrical base of the fire containment connector. The cylindrical base 100 may be cast from a metal alloy. It is open at both ends and may have a main body 102 and a circumferential band 104 at its female end 106. The circumferential band 104 may have an outer diameter that extends beyond an outer diameter of the main body 102. A plurality of lugs may extend from an outermost surface of the circumferential band 104 and one lug may be an indicator lug 108 that has a mark 110 on its face 112. The circumferential band 104 may contain a plurality of inner grooves that form the female end 106 of the cylindrical base 100.

The female end 106 may connect with a male coupling on a first fire hose. The connection may be tightened by rotating the cylindrical base 100 using the plurality of lugs that extend from the outermost surface of the circumferential band 104. A male end 114 of the cylindrical base 100 may be formed by a plurality of outer grooves 116. A female coupling on a second fire hose may be connected to the male end 114. The cylindrical base 100 may route water from the first fire hose to the second water hose.

The main body 102 of the cylindrical base 100 may contain a first groove 118 and a second groove 120. A first O-ring may fit in the first groove 118 and a second O-ring may fit in the second groove 120. The first O-ring and the second O-ring may be lubricated to facilitate rotation of a sleeve about the main body 102. A third groove 122 may be located between the second groove 120 and the plurality of outer grooves 116. A snap ring may fit in the third groove 122 to hold a cylindrical section of a sleeve against the circumferential band 104.

The cylindrical section of the sleeve may rotate about the main body 102 of the cylindrical base 100 until the fire containment connector is in an open position. An oblong opening 124 in the main body 102 may allow water to exit the cylindrical base 100 and enter a hollow protuberance of the sleeve because the oblong opening 124 and the hollow protuberance are aligned when the fire containment connector is open.

FIG. 2 is an illustration of the sleeve that rotates about the cylindrical base shown in FIG. 1. The sleeve 200 may be cast from the same metal alloy as the cylindrical base 100 and may have a cylindrical section 202 and a hollow protuberance 204. The cylindrical section 202 may be open at both ends. The hollow protuberance 204 may have two flat sides that are separated by an arch 206. Only one flat side 208 and part of the arch 206 are shown in FIG. 2. There may be a curved slit 210 in the arch 206. An angled hole 212 may be located at each end of the curved slit 210. As explained in detail below, a fan-shaped spray may be formed as water exits the curved slit 210 and the angled holes 212.

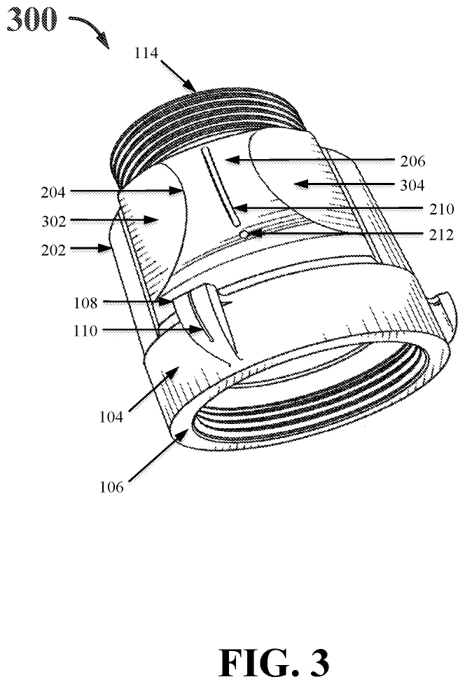

FIG. 3 is an illustration of the assembled fire containment connector. The cylindrical section 202 of the sleeve 200 may fit over the male end 114 of the cylindrical base 100 and move along the main body 102 until it rests against the circumferential band 104. It may be held in place by the snap ring in the third groove 122 located in the main body 102 of the cylindrical base 100. Although translational movement is prevented, the cylindrical section 202 of the sleeve 200 may rotate freely about the main body 102. The lubricated O-rings in the first groove 118 and the second groove 120 may facilitate rotation of the cylindrical section 202 about the main body 102.

The hollow protuberance 204 may include a first flat side 302, a second flat side 304, and an arch 206. The first flat side 302 and the second flat side 304 may be parabolic in shape, angled toward each other, and separated by the arch 206. The arch 206 may contain the curved slit 210, a first angled hole 212 located at a first end of the curved slit 210, and a second angled hole located at a second end of the curved slit 210.

Water may enter the hollow protuberance 204 from the oblong opening 124 in the main body 102 of the cylindrical base 100 when the hollow protuberance 204 and the oblong opening 124 are aligned. The curved slit 210 in the hollow protuberance 204 may expel a fan-shaped water spray and form a wall of water. In an implementation, the wall of water may saturate an area in the path of an advancing wildfire and rob the advancing wildfire of fuel. In addition, the wall of water may hinder the spread of embers and limit the number of ember-induced fires.

The curved slit 210 in the hollow protuberance 204 may align with the mark 110 on the indicator lug 108 when the fire containment connector 300 is in the open position. Rotation of the cylindrical section 202 of the sleeve 200 about the main body 102 may cause a distance between the curved slit 210 and the mark 110 on the indicator lug 108 to increase, a height of the wall of water to decrease, and a saturation distance of the wall of water to increase, provided all other factors that affect the wall of water (e.g., water pressure, wind speed, and wind direction) remain the same. Continued rotation of the cylindrical section 202 may cause the hollow protuberance 204 to move past the oblong opening 124 and water is no longer expelled from the curved slit 210 and the wall of water collapses.

The fire containment connector 300 may join a plurality of fire hoses and overlapping fan-shaped water sprays form a continuous wall of water. One end of the plurality of joined fire hoses may be a capped fire containment connector 300. The other end may be an open end of a fire hose (i.e., it is not joined to a fire containment connector). The open end of the fire hose may be connected to a pump that supplies water to the plurality of joined fire hoses.

When water is introduced into the plurality of joined fire hoses, the marks on the indicator lugs may be aligned with the curved slits in the hollow protuberances of the sleeves. The fire containment connectors may be in the open position because the oblong openings in the main bodies of the cylindrical bases and the hollow protuberances are aligned when the marks on the indicator lugs and the curved slits are aligned. As a result, water may be expelled from the curved slits, the first angled holes, and the second angled holes in an upward-directed spray. The cylindrical sections of the sleeves may be rotated about the main bodies of the cylindrical bases until water exits the curved slits at a desired angle. The continuous wall of water may have a height of approximately 32 to 37 feet and a saturation distance of approximately 30 to 35 feet provided all other factors that affect the continuous wall of water (e.g., water pressure, wind speed, and wind direction) remain the same.

The fire containment connector 300 may join a first pair of fire hoses that have a first diameter. The fire containment connector 300 may be resized to join a second pair of fire hoses that have a second diameter. The size of the wall of water may adjust proportionately to the new dimensions of the resized fire containment connector. For example, a fire containment connector 300 may connect to fire hoses that have a diameter of 2½ inches (i.e., the diameter of fire hoses used to contain wildfires). The fire containment connector 300 may be scaled down to connect to fire hoses having a diameter of 1 inch or scaled up to connect to fire hoses having a diameter of 6 inches.

The female end 106 and the male end 114 of the fire containment connector 300 may form a leak-resistant connection with a coupling on a third fire hose and a fourth fire hose when the female end 106, the male end 114, and the coupling have the same thread type. In the United States, the most common thread type used for fire hose couplings is the National Standard Thread or NST thread. Accordingly, the female end 106 and the male end 114 of the fire containment connector 300 may have NST threads so that leak-resistant connections are formed with fire hose couplings that have NST threads. Other thread types used in the U.S. may include National Pipe Straight Hose or NPSH threads and specialty threads. These thread types should be National Fire Protection Association (NFPA) compliant. In addition, the ends of the fire containment connector 300 may have thread types that fit fire hose couplings commonly used in other countries.

Because of the different thread types used domestically and internationally, the process for casting fire containment connectors should be flexible and adaptable. The process should have the capability to produce fire containment connectors whose ends have the various thread types listed above. Regardless of the thread type, the fire containment connector 300 should have the same purpose and functionality.

The fire containment container 300 may be joined to fire hoses whose couplings incorporate both threads and a locking mechanism. The threads may create a leak-resistant connection, while the locking mechanism may maintain the integrity of the connection. The various locking mechanisms only modify fire hose couplings. The locking mechanisms do not interfere with the purpose and functionality of the fire containment connector 300.

In the implementation discussed above, water enters the hollow protuberance 204 from the oblong opening 124 in the main body 102 of the cylindrical base 100 when the hollow protuberance 204 and the oblong opening 124 are aligned. Water is expelled from the curved slit 210, the first angled hole 212, and the second angled hole in the hollow protuberance 204 and a wall of water is formed. In another implementation, water may be replaced by a fire suppressant. The fire suppressant may enter the hollow protuberance 204 and may be expelled from the curved slit 210, the first angled hose 212, and the second angled hole. As a result, a wall of fire suppressant may be formed.

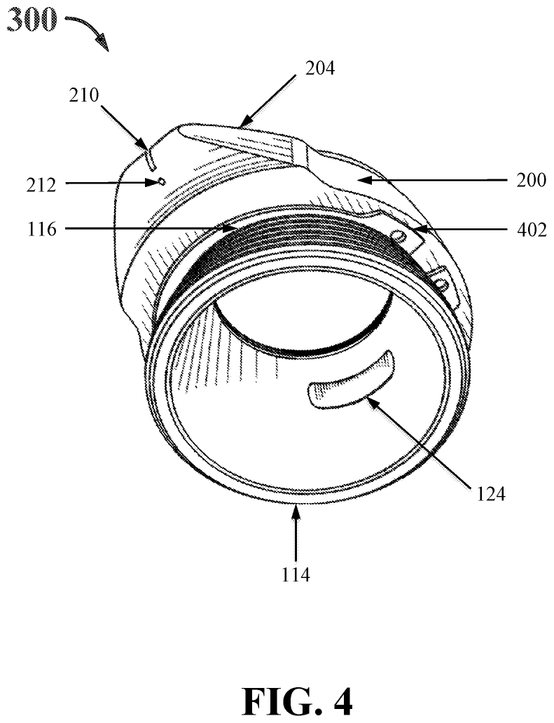

FIG. 4 is a flow-through view of the assembled fire containment connector shown in FIG. 3. In this view, the sleeve 200 has been slipped over the outer grooves 116 of the male end 114 of the cylindrical base 100. The sleeve 200 has been moved along the main body 102 until it rests against the circumferential band 104. A snap ring 402 has been placed in the third groove 122 to prevent translational movement of the sleeve 200.

The main body 102 may contain an oblong opening 124 near the circumferential band 104. The sleeve 200 may be rotated as needed to align the oblong opening 124 and the hollow protuberance 204. Once alignment occurs, the fire containment connector 300 may be in the open position. Water may exit the cylindrical base 100 and enter the hollow protuberance 204 via the oblong opening 124. An upward-directed water spray may exit the hollow protuberance 204 through the curved slit 210, the first angled hole 212, and the second angled hole.

FIG. 4 emphasizes the importance of the oblong opening 124 to the overall function of the fire containment connector 300. The oblong opening 124 makes it possible for water to move from the cylindrical base 100 to the hollow protuberance 204. Water flowing into the hollow protuberance 204 is the source of the upward-directed spray that is expelled from the curved slit 210, the first angled hole 212, and the second angled hole. Without the oblong opening 124, water could not enter the hollow protuberance 204 and an upward-directed spray would not form.

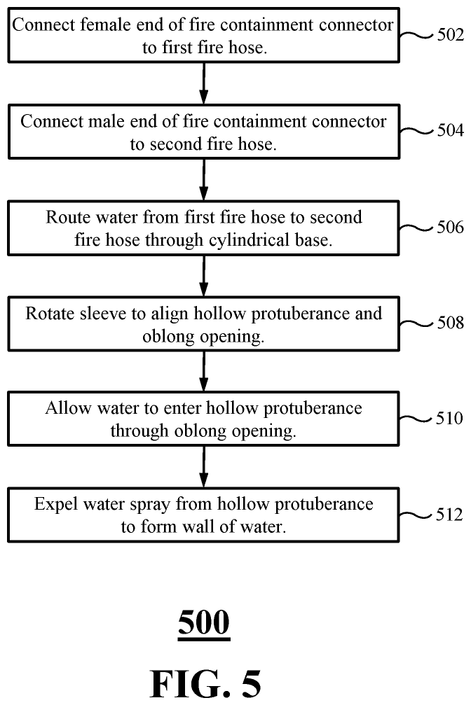

FIG. 5 is a process flow diagram of a method for containing a wildfire using the fire containment connector shown in FIGS. 3 and 4. The method 500 begins at block 502, where the female end of the fire containment connector may be connected to the male coupling on a first fire hose. At block 504, the male end of the fire containment connector may be connected to the female coupling on a second fire hose. At block 506, water may be routed from the first fire hose to the second fire hose through a cylindrical base of the fire containment connector.

The method 500 continues at block 508, where a cylindrical section of a sleeve may be rotated about a main body of the cylindrical base. The cylindrical section may be rotated until a hollow protuberance of the sleeve is aligned with an oblong opening in the main body. At block 510, water may be allowed to enter the hollow protuberance through the oblong opening. At block 512, a fan-shaped water spray may be expelled from a curved slit in the hollow protuberance and a wall of water may be formed. The wall of water may saturate an area in the path of an advancing wildfire and rob the advancing wildfire of fuel. Furthermore, the wall of water may hinder the spread of embers and limit the number of ember-induced fires.

The method 500 may include aligning the curved slit 210 with the mark 110 on the indicator lug 108 to open the fire containment connector 300. Rotating the cylindrical section 202 of the sleeve 200 about the main body 102 may cause an increase in a separation between the curved slit 210 and the mark 110 on the indicator lug 108, a decrease in a height of the wall of water, and an increase in a saturation distance of the wall of water, provided all other factors that affect the wall of water (e.g., water pressure, wind speed, and wind direction) remain the same. Continuing rotation of the cylindrical section 202 may cause the hollow protuberance 204 to move past the oblong opening 124, the curved slit 210 to cease expelling water, and the wall of water to collapse.

The method 500 may include replacing water with a fire suppressant. The method 500 may continue by allowing the fire suppressant to enter the hollow protuberance 204. The fire suppressant may exit the hollow protuberance 204 when it is expelled from the curved slit 210. Expelling the fire suppressant may result in forming a wall of fire suppressant.

The fire containment connector is integral to the formation of a wall of wall that diminishes the likelihood that a wildfire will continue to advance. A plurality of fire hoses are joined by the fire containment connector well in advance of the occurrence of a wildfire. The fire hoses may be joined to form segments of a certain length. The frequency and severity of wildfires in the surrounding area may determine the length of a segment and the number of segments needed. In an example, a smaller fire department in an area that has occasional small brush fires may need one or two segments that are a few hundred feet in length. In another example, a larger fire department in an area that has frequent wildfires may require multiple segments that are 500 to 5,000 feet in length. When the segments are connected, one end may be a capped fire containment connector and the other end may be an open-ended fire hose (i.e., the end is not joined to a fire containment connector). The open end of the fire hose may be connected to a pump that supplies water to the plurality of joined fire hoses.

Each fire containment connector may be inspected to make sure it is open before it is added to a segment. The position of the indicator lug may make it easy to determine if a fire containment connector is open. If the mark on the indicator lug is aligned with the curved slit in the hollow protuberance, the oblong opening in the main body of the cylindrical base is aligned with the hollow protuberance and the fire containment connector is open. If the mark on the indicator lug is not aligned with the curved slit, rotating the sleeve about the main body brings them into alignment and opens the fire containment connector.

The segments may be racked (i.e., loaded) on a transport vehicle. Each fire hose may be added to the transport vehicle in “lay flat” position which is the optimal hose racking method for quick offloading with the fire containment connector. After all the segments have been loaded, the transport vehicle is ready for deployment and may be stored until needed.

The transport vehicle may be deployed in the event of a wildfire. At the site of the wildfire, the segments may be unloaded from the transport vehicle. If the fire hoses were properly racked, the segments may be unloaded without kinking or tangling. The segments may be positioned as needed to contain the spreading wildfire.

The transport vehicle may be met at the site by a pumper truck, a tanker, a tinder, or a dump tank containing water. Built-in pumps or portable pumps may move water from these sources to the connected segments. Alternatively, water may be supplied from natural sources such as rivers, lakes, and ponds. Portable pumps may be used to transfer water from a natural source to the connected segments.

The pumps may be turned on and water is expelled from the curved slits in an upward-directed spray. A firefighter may rotate the sleeves on the fire containment connectors until water sprays out of the curved slits at a desired angle and a wall of water is created. Alternatively, individual sleeves may be rotated by different amounts and water exits the curved slits at different angles. Hence, the sleeves on the fire containment connectors may be adjusted as needed to contend with the changing periphery of a wildfire. Stakes may be used to stabilize the fire containment connectors so that the positions of the sleeves may be maintained.

Flexibility can be introduced into the use of fire hoses joined by the fire containment connector in ways other than those described above. For example, double connectors may be placed between fire hoses. One of the two fire containment connectors may expel water in one direction while the other may expel water in the opposite direction. As a result, the saturation distance may increase to approximately 60 feet or more. Some of the fire containment connectors may be turned off only if water is needed further down the line of connected fire hoses. Furthermore, use of the fire containment connector is not limited to containing wildfires. It may be used to fight fires in industrial, commercial, and residential areas.

Use of fire hoses joined by the fire containment connector may confer some benefits. For example, the connected fire hoses may be deployed at night or in high winds when the use of other equipment may be limited. Furthermore, water may be expelled from the curved slits at high pressure. As a result, the wall of water may extend a considerable distance from the fire hoses joined by the fire containment connector. Firefighters may remain behind the wall of water and minimize their exposure to intense heat, smoke, and flames.

Numerous firefighters may cover only a limited area when implementing conventional fire containment techniques. Furthermore, a considerable amount of equipment may be required to support the firefighters' efforts. The use of the fire containment connector may result in fire containment techniques that use less resources and cover more area. A few firefighters using a reduced amount of equipment may cover as much as 5,000 linear feet with a width up to 60 feet or more when fire hoses joined by the fire containment connector are deployed. Accordingly, firefighters and equipment may become available to fight the same wildfire in other areas or a different wildfire located elsewhere. As a result, fewer acres may be destroyed and less carbon dioxide may be emitted into the atmosphere.

Reference to “an example,” “another example,” “an implementation,” or “another implementation” means that a particular feature is included in at least some examples or implementations, but not necessarily in all examples or implementations, of the present techniques. The various occurrences of “an example” or “an implementation” are not necessarily referring to the same example or implementation.

Not all features described and illustrated herein need to be included in a particular embodiment or embodiments. For example, if the specification states a feature “may” be included, that particular feature is not required to be included. If the specification refers to “a” feature, that does not mean there is only one of the feature.

Some embodiments have been described by referring to particular examples or implementations. However, other examples and implementations are possible. The examples and implementations of the present techniques are not limited to those disclosed herein. Additionally, the arrangement of the features and the sequence of the functions described above or illustrated in the drawings do not need to be arranged or sequenced in the particular way described or illustrated. Other arrangements or sequences are possible.

Features shown in the drawings may have the same reference number to suggest that the features are similar. Alternatively, features shown in the drawings may have different reference numbers to suggest that the features are different. However, a feature may be flexible enough to be present in some or all of the examples or implementations described above or shown in the drawings. Various features described herein or depicted in the drawings may be designated as a first feature, a second feature, etc. It is arbitrary which feature is referred to as the first feature, the second element, and so on.

Details of an aforementioned example or implementation may apply to one or more embodiments. For example, all optional features of the fire containment connector may be included in the method described above. Furthermore, a process flow diagram has been used herein to describe an embodiment. However, the present techniques are not limited to that diagram or the corresponding description. For example, the process exemplified in the diagram need not progress through each box or in exactly the same order as illustrated.

The present techniques are not restricted to the particular details described herein. Those skilled in the art having the benefit of this disclosure will appreciate that many other variations of the foregoing descriptions and accompanying drawings are possible and remain within the scope of the present techniques. Accordingly, the scope of the present techniques is defined by the following claims and any amendments thereto.

What is claimed is:

1. A fire containment connector, comprising:
a female end to connect with a male coupling on a first fire hose;
a male end to connect with a female coupling on a second fire hose;
a cylindrical base to route water from the first fire hose to the second fire hose;
a cylindrical section of a sleeve to rotate about a main body of the cylindrical base until the fire containment connector is in an open position;
an oblong opening in the main body to allow water to exit the cylindrical base and enter a hollow protuberance of the sleeve when the oblong opening and the hollow protuberance are aligned; and
a curved slit in the hollow protuberance to expel a fan-shaped water spray and form a wall of water.

2. The device of claim 1, wherein the wall of water saturates an area in a path of an advancing wildfire and robs the advancing wildfire of fuel and hinders a spread of embers and limits a number of ember-induced fires.

3. The device of claim 1, comprising a circumferential band at the female end of the cylindrical base and an outer diameter of the circumferential band extends beyond an outer diameter of the main body.

4. The device of claim 3, wherein a plurality of lugs extends from an outermost surface of the circumferential band and one lug is an indicator lug that has a mark on its face.

5. The device of claim 1, wherein the main body of the cylindrical base comprises a first groove and a second groove, a first O-ring fits in the first groove, a second O-ring fits in the second groove, and the first O-ring and the second O-ring are lubricated to facilitate rotation of the sleeve about the main body.

6. The device of claim 1, wherein the cylindrical section of the sleeve is held against the circumferential band by a snap ring that fits in a third groove in the main body.

7. The device of claim 1, wherein the hollow protuberance comprises a first flat side, a second flat side, and an arch, wherein the first flat side and the second flat side are parabolic in shape, angled toward each another, and separated by the arch, and wherein the arch comprises the curved slit, a first angled hole located at a first end of the curved slit, and a second angled hole located at a second end of the curved slit.

8. The device of claim 1, wherein the curved slit aligns with the mark on the indicator lug when the fire containment connector is in the open position.

9. The device of claim 8, wherein rotation of the cylindrical section of the sleeve about the main body causes a separation between the curved slit and the mark on the indicator lug to increase, a height of the wall of water to decrease, and a saturation distance of the wall of water to increase.

10. The device of claim 9, wherein continued rotation of the cylindrical section of the sleeve causes the hollow protuberance to move past the oblong opening, the curved slit to cease expelling water, and the wall of water to collapse.

11. The device of claim 1, wherein the fire containment connector joins a plurality of fire hoses and overlapping fan-shaped water sprays form a continuous wall of water.

12. The device of claim 1, wherein the fire containment connector joins a first pair of fire hoses that have a first diameter, the fire containment connector is resized to join a second pair of fire hoses that have a second diameter, a resized fire containment connector is obtained, and a size of the wall of water adjusts proportionately to the resized fire containment connector.

13. The device of claim 1, wherein the female end and the male end of the fire containment connector form a leak-resistant connection with a coupling on a third fire hose and a fourth fire hose when the female end, the male end, and the coupling have the same thread type.

14. The device of claim 1, wherein water is replaced by a fire suppressant, the fire suppressant enters the hollow protuberance and is expelled from the curved slit, the first angled hole, and the second angled hole and a wall of fire suppressant is formed.

15. A method for using a fire containment connector, comprising:
connecting a female end of the fire containment connector to a male coupling on a first fire hose;
connecting a male end of the fire containment connector to a female coupling on a second fire hose;
routing water from the first fire hose to the second fire hose through a cylindrical base of the fire containment connector;
rotating a cylindrical section of a sleeve about a main body of the cylindrical base until a hollow protuberance of the sleeve is aligned with an oblong opening in the main body;
allowing water to exit the cylindrical base and enter the hollow protuberance through the oblong opening; and
expelling a fan-shaped water spray from a curved slit in the hollow protuberance to form a wall of water.

16. The method of claim 15, wherein the wall of water saturates an area in a path of an advancing wildfire and robs the advancing wildfire of fuel and hinders a spread of embers and limits a number of ember-induced fires.

17. The method of claim 15, comprising aligning the curved slit with a mark on an indicator lug to open the fire containment connector.

18. The method of claim 17, comprising rotating the cylindrical section of the sleeve about the main body and increasing a separation between the curved slit and the mark on the indicator lug, decreasing a height of the wall of water, and increasing a saturation distance of the wall of water.

19. The method of claim 18, comprising continuing rotation of the cylindrical section to cause the hollow protuberance to move past the oblong opening, the curved slit to cease expelling water, and the wall of water to collapse.

20. The method of claim 15, comprising replacing water with a fire suppressant, allowing the fire suppressant to enter the hollow protuberance, expelling the fire suppressant from the curved slit, and forming a wall of fire suppressant.
